(19) United States
(12) Patent Application Publication
(10) Pub. No.: US 2005/0232273 A1
(43) Pub. Date: Oct. 20, 2005

(54) Communications system and a gateway device

(75) Inventor: Johji Suzuki, Tokyo (JP)

Correspondence Address: FOLEY AND LARDNER;SUITE 500, 3000 K STREET NW, WASHINGTON, DC, 20007, US

(73) Assignee: NEC Personal Products, Ltd.

(21) Appl. No.: 11/081,744

(22) Filed: Mar. 17, 2005

(30) Foreign Application Priority Data
Mar. 19, 2004 (JP) 2004-080361

(51) Int. Cl. H04L 12/56

(52) U.S. Cl. 370/392

(57) ABSTRACT

A gateway device connecting an internal network to an external network includes a command analysis and translation section and a message processing section. The command analysis and translation section translates an internal address included in a command used on its corresponding internal network into an external address represented according to an address system used on the external network. The message processing section encapsulates the address-translated command in a message and transfers the message to the other gateway device on the other internal network through the external network and a message exchange server.

### BACKGROUND OF THE INVENTION

1. Field of the Invention

The present invention relates to communications techniques allowing data communications between communication devices each connected to different internal networks through an external network. In particular, the present invention relates to a gateway corresponding to each internal network, allowing data communication of a communication device within a corresponding internal network with another communication device connected to a different internal network.

2. Description of the Related Art

In recent years, as standards for home networking, various standards, such as UPnP (Universal Plug and Play), have been developed and formalized. Technologies have been established which allow communication devices connected to the same internal network (home network) to communicate content data (video, audio/voice, still images, etc.) to each other.

In contrast, still developing are technologies which interconnect internal networks through an external network such as the Internet to allow communication devices each connected to the different internal networks to communicate content data to each other.

For example, in an environment where internal networks are interconnected through the Internet, an address system is changed on a gateway (GW) device located between the internal network and the Internet. For example, ad-hoc assigned local addresses are used on the internal network, whereas uniquely assigned global addresses are used on the Internet. Moreover, it is quite natural that the respective address systems used on the internal networks also differ from one anther. In addition, for the purpose of ensuring security, a protocol used on a normal internal network imposes restrictions on data communication performed through a gateway device (firewall, etc.).

As a technology to allow communication devices connected to different internal networks to communicate content data in such an environment, it is known that a virtual network (VPN: Virtual Private Network) is used to directly interconnect devices connected to different internal networks. According to this technology, when a first communication device connected to an internal network accesses a second communication device connected to another internal network, the first communication device can behave as if it was on the same internal network as the second communication device.

On the other hand, there has been proposed another technology which allows communication devices connected to the Internet to communicate content data to each other at low cost, with no need for an advanced knowledge (see Japanese Patent Application Unexamined Publication No. 2003-85105). According to this conventional technology, when a communication device has stored content data in a server, the communication device sends a mail server information required to retrieve the content data. Then, another communication device receives the information from the mail server and, based on this information, retrieves the content data from the server. Accordingly, it is conceivable that, if this technology is applied, communication devices connected to different internal networks can obtain content data from one another. In other words, content data can be communicated between communication devices connected to different internal networks.

However, the prior arts as described above have the following disadvantages.

First, in the technology utilizing VPN, for users to use a VPN, a special server for VPN needs to be installed. Since this installation requires a high-degree technique, the users themselves need to learn about such a high-degree technique. Hence, recently, a server for VPN installed by a provider or the like is widely used, allowing users to easily use VPN. In this case, however, the users have to pay a large fee to the provider or the like. That is to say, there has been a problem that a general user can use a VPN only either by installing a special server after acquiring a high-degree knowledge him/herself or by paying a large fee to a provider or the like.

Further, the technology disclosed in Japanese Patent Application Unexamined Publication No. 2003-85105 provides a scheme to allow communication devices connected to the Internet to communicate content data to each other. Therefore, to apply this technique to communication devices connected to different internal networks, it is necessary for each of the communication devices to be compatible with the scheme by newly constructing a platform on each communication device (for example, by newly installing hardware such as a server, software such as an application, etc.). Accordingly, there has been not only a problem that each communication device connected to the internal network becomes expensive, but also a problem that, among the communication devices, a communication device that does not comply with the scheme cannot communicate content data with an outside communication device.

### SUMMARY OF THE INVENTION

Therefore, an object of the present invention is to provide a communications system and a gateway device which achieve content communication between communication devices connected to different internal networks through an external network without the need for knowledge of high-degree networking.

Another object of the present invention is to provide a communications system and a gateway device which achieve content communication between communication devices on different internal networks through an external network without the need of constructing a new platform on each communication device.

According to the present invention, a plurality gateway devices is provided each corresponding to a plurality of internal networks and connects a corresponding internal network and an external network. A message exchange server is connected to the external network, allowing message communications between the gateway devices through the external network.

The gateway device includes an address translator and a message processor. The address translator translates a first address represented according to a first address system on the internal network into a second address represented according to a second address system on the external network to produce an address-translated command. The first address is included in a predetermined command received from a corresponding internal network. The message processor encapsulates the address-translated command in a message and the message is transmitted to another gateway device through the message exchange server over the external network.

The address translator, when the predetermined command is a command necessary for content communication, translates each of a device address and a content address included in the predetermined command as a first address. The device address identifies a communication device which is a source of the predetermined command within the corresponding internal network and the content address identifies content data to be provided by the communication device.

The gateway device may further include an address translation table storing an address represented according to the first address system and an address represented according to the second address system, which are related to each other. In this case, the address translator writes a before-translation address and an after-translation address onto the address translation table when address translation of the first address has been done.

The gateway device may further include a destination table storing a destination address of the predetermined command to be encapsulated in the message and a transfer destination address of the message, the transfer destination address being an address of the other gateway device to which the message is to be transmitted, wherein the destination address and the transfer destination address are related to each other. When the destination address is included in the destination table, the address translator performs address translation of the first address and the message processor encapsulates the address-translated command in the message to transfer the message to the other gateway device whose address is the transfer destination address related to the destination address in the destination table.

When having received a message from the other gateway device through the message exchange server over the external network, the message processor may decapsulate the message received to extract a received command. The address translator may translate an address included in the received command from the second address system into the first address system as necessary before transmitting an address-translated received command to the internal network.

As described above, in a gateway device provided for an internal network, an address that is contained in a specific command used on the internal network and that is represented according to an address system used on the internal network, is translated into an address represented according to an address system used on an external network. Then, the command subjected to the address translation is encapsulated in a message, and the message is transferred to another gateway device provided for another network through the external network and a message exchange server.

Thus, even if the address system used on the internal network differs from the address system used on the external network, or even if the respective address systems used on the internal networks differs from one another, communication devices connected to the different internal networks can communicate a command required to communicate content data, as the specific command, through the external network. Accordingly, the communication devices can obtain the content data from one another based on the command, for example, by playing the content data, downloading the content data, and so on.

Moreover, unlike the technology utilizing VPN or the like which connects an internal network to a remote internal network, according to the present invention, a new platform does not need to be constrcuted because a command is communicated by utilizing a platform that is for message services (e.g., electronic mail messages, instant messages, etc.) provided by a massage exchange server and that has been already constructed on a communication device in an ordinary home. In addition, for this reason, a communication device can be provided at low cost, and no knowledge of high-degree networking is required of a user.

Further, since the message services provided by the message exchange server are utilized, it is possible to communicate a command within a range in which a message can be communicated. For example, even if the protocol of a lower layer differs from that of another, or even if the communication of data is restricted for the reason of security, a command can be communicated as long as the communication is allowed within a range in which a message can be communicated.

Furthermore, since a command is communicated by being encapsulated in a message, the present invention can easily cope with the extension of function on an internal network. For example, a gateway device basically does not need to be changed even when a new command is defined in a protocol used on its corresponding internal network. In this case, it suffices that only a communication device connected to an end of the internal network will handle the newly defined command.

### BRIEF DESCRIPTION OF THE DRAWINGS

FIG. 1 is a diagram showing the configuration of a communications system according to an embodiment of the present invention;

FIG. 2 is a block diagram showing the configuration of a gateway device of FIG. 1;

FIG. 3 is a flowchart showing an operation of the gateway device as shown in FIG. 2 when transmitting a command received from an internal network to an external network;

FIG. 4 is a flowchart showing an operation of the gateway device as shown in FIG. 2 when transmitting a command received from the external network to an internal network;

FIG. 5 is a diagram showing an example of destination tables 26 provided in gateway devices 10A and 10B;

FIG. 6 is a diagram showing an example of address translation tables 25 provided in gateway devices 10A and 10B; and

FIG. 7 is a diagram showing another example of destination tables 26 provided in gateway devices 10A and 10B.

### DETAILED DESCRIPTION OF THE PREFERRED EMBODIMENT

Hereinafter, a preferred embodiment of the present invention will be described with reference to the accompanying drawings.

1. Communications System

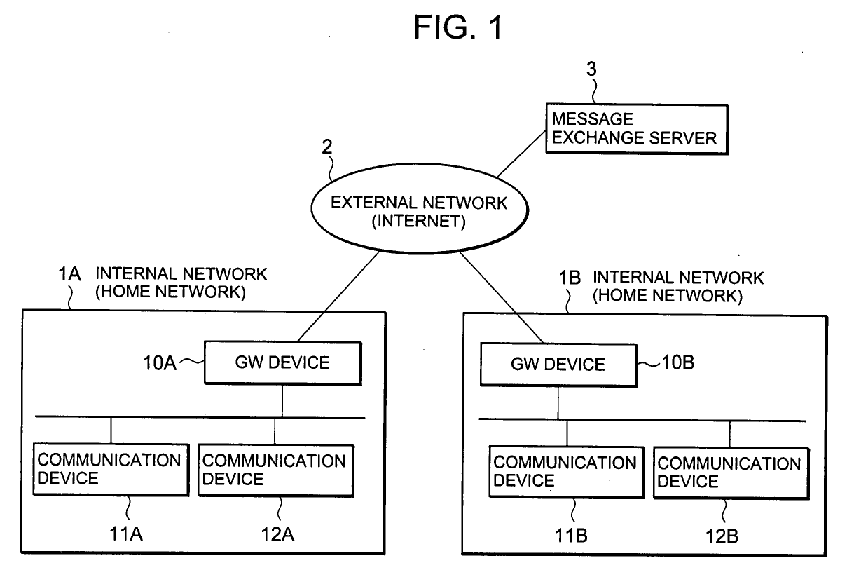

Referring to FIG. 1, a communications system according to the embodiment of the present invention has gateway (GW) devices 10A and 10B and a massage exchange server 3. The GW devices 10A and 10B are provided for two internal networks (e.g. home networks) 1A and 1B, respectively, and connect the respective internal networks 1A and 1B to an external network (Internet) 2. The message exchange server 3 is connected to the external network 2 and receives and sends messages (electronic mail messages, chat messages, instant messages, etc.) between the GW devices 10A and 10B. Note that, although two internal networks (1A, 1B) are connected to the external network 2 in FIG. 1, there is no particular limit to the number of internal networks to be connected to the external network 2, except that the number should be not less than two. An internal network 1A, 1B is typically a home network or another similar network such as an in-house network, an on-premises network, or a local network.

The internal network 1A is connected to the GW device 10A as well as communication devices 11A and 12A, each of which may be a server, a terminal or the like. Further, the internal network 1B is connected to the GW device 10B as well as communication devices 11B and 12B, each of which may be a server, a terminal or the like.

The communication devices 11A and 12A connected to the internal network 1A can access the external network 2 through the GW device 10A. The communication devices 11B and 12B connected to the internal network 1B can access the external network 2 through the GW device 10B.

Moreover, the communication devices 11A and 12A connected to the internal network 1A and the communication devices 11B and 12B connected to the internal network 1B can perform message communication with each other via the message exchange server 3.

Furthermore, within the internal network 1A, the communication devices 11A and 12A connected to the internal network 1A communicate specific commands of a protocol used on the internal network 1A to each other. When a specific command is a command (such as “play” or “download”) required to communicate content data (video, audio, a still image, etc.), any of the communication devices 11A and 12A can obtain the content data from another communication device on the same internal network 1A based on that command. Similarly, within the internal network 1B, the communication devices 11B and 12B connected to the internal network 1B communicate specific commands of a protocol used on the internal network 1B to each other. When a specific command is a command required to communicate content data, any of the communication devices 11B and 12B can obtain the content data from another communication device on the same internal network 1B based on that command.

The above-described environment is publicly known already. In such an environment, each of the GW devices 10A and 10B according to the present invention has the following functions: converting an address that is contained in a specific command used on its corresponding internal network 1A or 1B and is represented according to an address system used on its corresponding internal network 1A or 1B, into an address represented according to an address system used on the external network 2; then encapsulating the command in a message; and then transferring the message to the other GW device 10B or 10A on the other internal network 1B or 1A, through the external network 2 and the message exchange server 3.

With these functions, the respective communication devices connected to the different internal networks 1A and 1B can communicate a command required for content communication, as a specific command, through the external network 2, even if the address systems used on the internal networks 1A and 1B differ from the address system used on the external network 2, or even if the address systems used on the internal networks 1A and 1B differ from each other. Accordingly, any of the communication devices can obtain the content data from another communication device connected to the other internal network 1A or 1B based on the command, for example, by playing the content data, downloading the content data, and so on.

2. Gateway Device

2.1) Configuration

Now, the configuration and operation of the GW device 10A, 10B will be described in more detail. In the description below, it will be assumed that local addresses which are assigned ad hoc within each of the internal networks 1A and 1B are used as addresses on the internal network 1A and 1B, and that global addresses which are uniquely assigned in the external network 2 are used as addresses on the external network 2. Moreover, it will be assumed that the message exchange server 3 is a server which receives and sends electronic mail messages between the GW devices 10A and 10B, and that an electronic mail address is a transfer destination address, which is the address of the GW device 10A or 10B that is to be the destination of a message. Furthermore, it will be assumed that a command required for content communication is transferred as a specific command between the GW devices 10A and 10B.

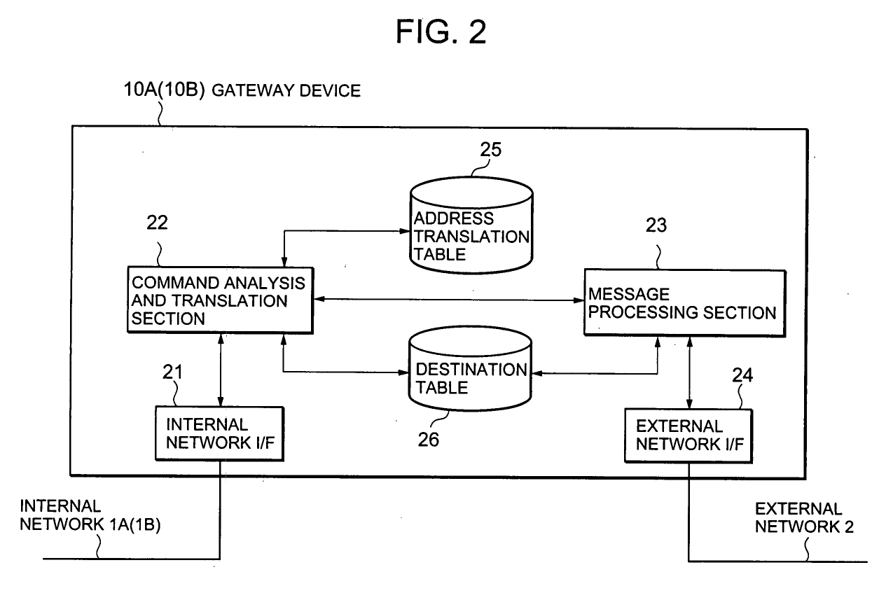

Referring to FIG. 2, the GW device 10A (or 10B) is provided with an internal network interface (I/F) 21, a command analysis and translation section 22, a message processing section 23, an external network interface (I/F) 24, an address translation table 25, and a destination table 26. Although the components in the GW device 10A are taken as an example to describe the operations thereof here, the components in the GW device 10B also operate similarly.

The internal network I/F 21 is a network interface to the internal network 1A and has a function of processing a network protocol on the internal network 1A. The network interface is, for example, Ethernet or the like. The network protocol is, for example, TCP/IP (Transmission Control Protocol/Internet Protocol), UPnP or the like.

The command analysis and translation section 22 has a function of translating an internal address into an external address. The internal address is represented according to the address system used on the internal network 1A and is contained in a command required for content communication that is received from the internal network 1A. The external address is represented according to the address system used on the external network 2. Moreover, the command analysis and translation section 22 has a function of, if necessary, translating an external address contained in a command received from the external network 2 into an internal address used on the internal network 1A, and transmitting the command to the internal network 1A.

The message processing section 23 has a function of encapsulating the address-translated command received from the command analysis and translation section 22 into a message, and then transferring the message to the other internal network 1B through the external network 2 and the message exchange device 3. At this time, the massage may be transferred to the internal network 1B in the form of a user-readable text format. Moreover, the message processing section 23 has a function of decapsulating a message received from the external network 2 to extract a command from the message.

The external network I/F 24 is a network interface to the external network 2 and has a function of processing a network protocol on the external network 2. The network interface is, for example, ADSL (Asymmetric Digital Subscriber Line), FTTH (Fiber To The Home), a telephone line interface, or the like. The network protocol is, for example, TCP/IP or the like.

The address translation table 25 is used to translate an address included in a command as described above. The address translation table 25 is a table storing an internal address represented according to the address system on the internal network 1A and an external address represented according to the address system on the external network 2, wherein the internal address is related to the external address. When translating an internal address into an external address as described above, the command analysis and translation section 22 writes the addresses before and after the translation onto the address translation table 25. The command analysis and translation section 22 may be configured to include a well-known address translation function, such as NAT (Network Address Translation).

The destination table 26 is referenced to determine whether or not a command of the protocol used on the internal network 1A should be encapsulated in a message. In this destination table 26, the following two types of addresses are written in relation to each other: a command destination address of the command that should be encapsulated in a message to be transferred; and a transfer destination address indicating the address of a GW device on another internal network to which the message having the command encapsulated therein is transferred. Note that the command destination address written in the destination table 26 may be a TCP/UDP (Transmission Connection Protocol/User Datagram Protocol) port number, a combination of a TCP/UDP port number and an IP address, or a combination of a TCP/UDP port number and a URI (Uniform Resource Identifier).

It should be noted that the above-described functions of the gateway device may be implemented on a program-controlled processor by running a command analysis and translation program, a message processing program and other necessary programs thereon.

2.2) Operation

Hereinafter, an operation of the GW device 10A, 10B will be described. Here, a description will be given of the operation in the case where a command is transmitted from the internal network 1A to the internal network 1B.

It will be assumed that, in the destination table 26 of each of the GW devices 10A and 10B, the following two types of addresses are previously written in relation to each other: a command destination address of a command that should be encapsulated in a message and always be transferred to the other internal network, and a transfer destination address, which is the address of the GW device on the other internal network to which the massage having the command encapsulated therein is transmitted.

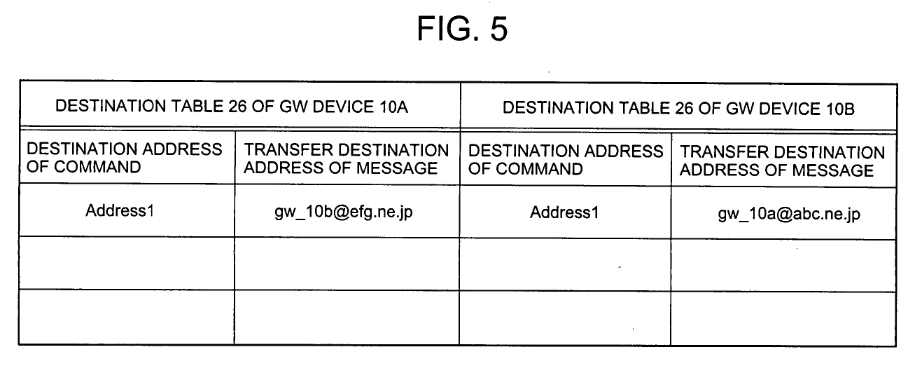

For example, as shown in FIG. 5, the destination table 26 of the GW device 10A contains a command destination address “Address1” and a corresponding transfer destination address “gw_{—}10b@efg.ne.jp,” which is the address of the GW device 10B on the internal network 1B to which the message having the command encapsulated is transmitted. Similarly, the destination table 26 of the GW device 10B contains an address “Address1” included in a command and a corresponding transfer destination address “gw_{—}10a@abc.ne.jp,” which is the address of the GW device 10A on the internal network 1A to which the message having the command encapsulated is transmitted.

In FIG. 5, although the destination tables 26 of the GW devices 10A and 10B specifies only one transfer destination for the message, a plurality of transfer destinations for a message may be specified. Additionally, in this example, each of the GW devices 10A and 10B uses a port number for the command destination address, and therefore both the command destination addresses are the same “Address1.”

First, a description will be given of the operation of the GW device 10A in the case where a command is transmitted from a communication device within the internal network 1A to the internal network 1B.

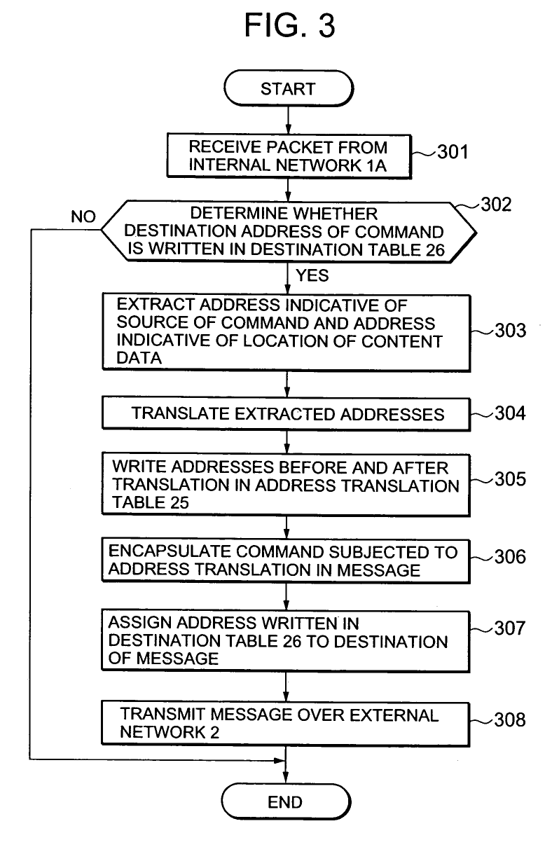

Referring to FIG. 3, first, the command analysis and translation section 22 receives a packet containing a command from a communication device connected to the internal network 1A, via the internal network I/F 21 (Step 301). It is assumed here that the command analysis and translation section 22 has received a packet addressed to “Address1” from the communication device 11A.

Subsequently, the command analysis and translation section 22 extracts the destination address from the command contained in the received packet and determines whether or not the extracted destination address is written in the destination table 26 (Step 302).

When the extracted destination address is not written in the destination table 26 (NO at step 302), the GW device 10A thereafter carries out only the processing of connecting the internal network 1A to the external network 2, as a normal GW device.

When the extracted destination address is written in the destination table 26 (YES at step 302), the processing on the command is carried out. In this example, the destination address of the command is “Address1,” which is a port number or the like on the GW device 10B on the internal network 1B, as shown in FIG. 5. Therefore, the following processing will be performed.

The command analysis and translation section 22 further extracts a source address from the command to identify the communication device 11A as a source of the command, and also extracts a content address to identify the location of content data provided by the communication device 11A (Step 303). The content address for specifying the content data provided by the communication device 11A may be the address of a function (service) that the communication device 11A has, or may be the address of the content data itself. Incidentally, if a list of multiple pieces of content data is written in the command, the respective addresses to identify the pieces of the content data are written in the command.

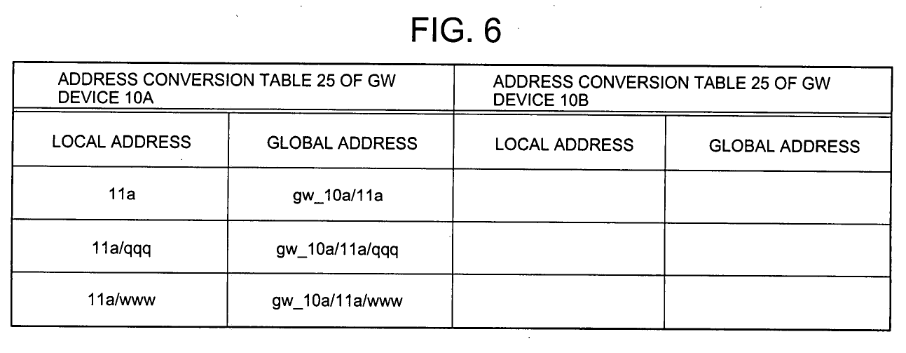

For example, as shown in FIG. 6, the command analysis and translation section 22 extracts the address “11a” of the communication device 11A, and the addresses “11a/qqq” and “11a/www” of respective pieces of content data “qqq” and “www” possessed by the communication device 11A.

In this example, the addresses “11a,” “11a/qqq” and “11a/www” extracted from the command are local addresses. Therefore, the command analysis and translation section 22 translates the local addresses into global addresses (Step 304) and writes both the local and global addresses related to each other in the address translation table 25 as shown in FIG. 6 (Step 305).

In FIG. 6, the global address to specify the communication device 11A is “gw_{—}10a/11a,” made of the global address “gw_{—}10a” of the GW device 10A with the addition of a character (or characters) “11a” for identifying the communication device 11A. Moreover, the global addresses to specify the respective pieces of the content data provided by the communication device 11A are “gw_{—}10a/11a/qqq” and “gw_{—}10a/11a/www,” made of the address “gw_{—}10a/11a” with the addition of characters capable of identifying the content data “qqq” and “www,” respectively.

As will be described later, the command subjected to the address translation is transferred to the GW device 10B on the other internal network 1B that is written in the destination table 26. From then on, when the communication devices 11B and 12B, which are connected to the same internal network 1B as the GW device 10B, request for a play, download or the like of the content data possessed by the communication device 11A, the communication devices 11B and 12B are to designate the global address specifying the desired content data. At this time, if the communication devices 11B and 12B are expected to also designate a port number, the command analysis and translation section 22 writes a port number for the communication device 11A, in the command. In this case, the port number for the communication device 11A is also subjected to address translation, and the port numbers before and after the translation are also written in the address translation table 25.

Next, the command analysis and translation section 22 outputs the command subjected to the address translation to the message processing section 23. The message processing section 23 encapsulates the command in a message (Step 306). Note that, if the destination address of the command is not contained in the command itself (e.g., in the case of the destination address of the command being contained in the header of the packet), then the command analysis and translation section 22 also performs the encapsulation of the command in a message after translating the destination address of the command into a global address.

Further, the message processing section 23 assigns the destination address that is stored in the destination table 26 as a message transfer destination address associated with the command in question, to the transfer destination of the message having the command encapsulated therein (Step 307). Here, as shown in FIG. 5, since the destination address of the command is “Address1,” the transfer destination address of the message having the command encapsulated therein is set for “gw_{—}10b@efg.ne.jp” in order to transfer the message to the GW device 10B on the internal network 1B. In addition, a specific code may be appended to the header or payload of the message in order to make it recognizable that the command is encapsulated. Further, when the command is encapsulated, code conversion processing may be carried out on character codes written in the command. However, if the character codes written in the command include a character code that cannot be transmitted in the form of a message, then such a character code should be always subjected to the code conversion processing. Furthermore, in order to prevent the eavesdropping and/or manipulation of the massage to be transmitted to the internal network 1B, authentication processing and/or encryption processing, such as PGP (Pretty Good Privacy), may be carried out on the message after the command has been encapsulated in the message.

Thereafter, the message processing section 23 transmits the message having the command encapsulated therein over the external network 2, via the external network I/F 24 (Step 308). This message is transmitted to the GW device 10B by the message exchange server 3.

Next, a description will be given of operations of the GW device 10B in the case where a command transmitted from the internal network 1A is received by the gateway device 10B in the internal network 1B.

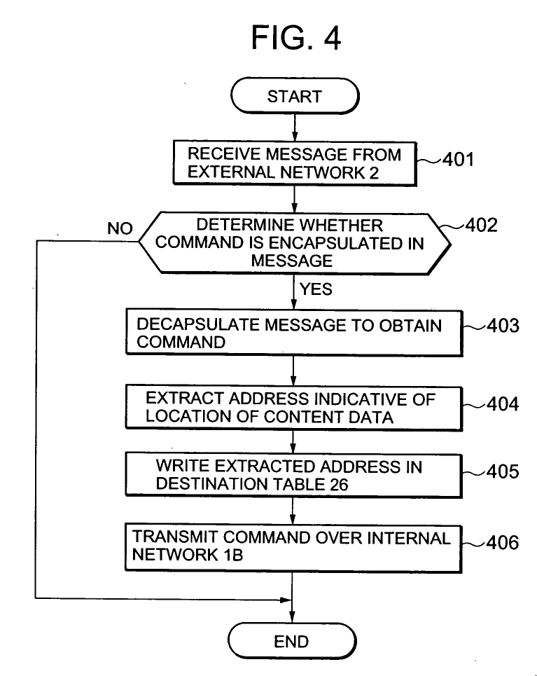

Referring to FIG. 4, first, the message processing section 23 receives a message from the external network 2 via the external network I/F 24 (Step 401).

Subsequently, the message processing section 23 determines whether or not a command is encapsulated in the message received from the external network 2 (Step 402). When a command is encapsulated in the message (YES at step 402), the message processing section 23 decapsulates the received message to extract a command (Step 403) and outputs the command to the command analysis and translation section 22. In this example, a message in which a command is encapsulated has been received from the internal network 1A and therefore the command is obtained by decapsulating the message.

Next, from the command outputted from the message processing section 23, the command analysis and translation section 22 extracts an address to specify content data from the command (Step 404). It is assumed here that the addresses “gw_{—}10a/11a/qqq” and “gw_{—}10a/11a/www” of the respective pieces of the content data “qqq” and “www” have been extracted.

Hereupon, the command analysis and translation section 22 does new writing in the destination table 26 so that the address to specify the content data extracted as mentioned above is written as a destination address of a command, and that the address of the GW device 10A on the other internal network 1A, which is the source of the command outputted from the message processing section 23, is written as a transfer destination address of a message (Step 405).

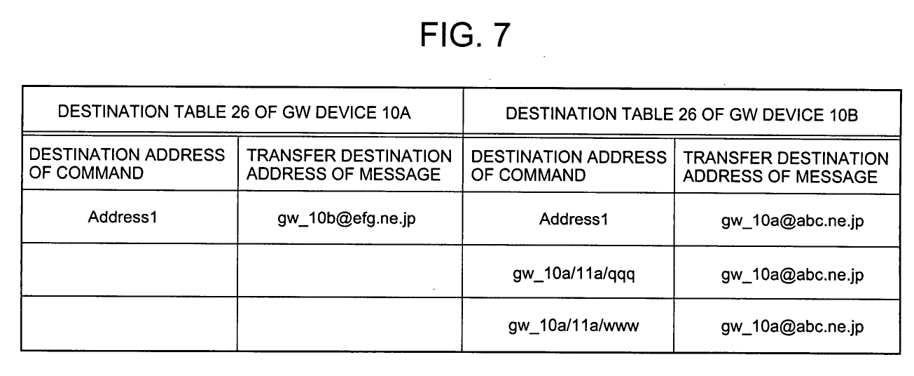

For example, as shown in FIG. 7, the address “gw_{—}10a/11a/qqq” to specify the content data “qqq,” is written as the command destination address in relation to the address “gw_{—}10a@abc.ne.jp” of the GW device 10A on the internal network 1A, which is the transfer destination address of the message having the command encapsulated therein. Moreover, the address “gw_{—}10a/11a/www” to specify the content data “www,” is written as the command destination address in relation to the address “gw_{—}10a@abc.ne.jp” of the GW device 10A on the internal network 1A, which is the transfer destination address of the message having the command encapsulated therein.

Accordingly, when the destination address of a command received from the communication device 11B or 12B connected to the internal network 1B is “gw_{—}10a/11a/qqq” or “gw_{—}10a/11a/www”, the GW device 10B can transfer a massage having the command encapsulated therein to the GW device 10A on the internal network 1A, through the procedures from Step 303 to Step 308 in FIG. 3. Therefore, the communication device 11A that has received the command through the GW device 10A can provides the corresponding content data “qqq” or “www” toward the internal network 11B so that the communication device 11B or 12B on the internal network 1B can perform playing, downloading, or the like of the content data based on the command. Thus, the communication devices connected to the different internal networks 1A and 1B allow communication of content data through the external network 2.

Thereafter, the command analysis and translation section 22 transmits the command outputted from the message processing section 23 over the internal network 1B, via the internal network I/F 21 (Step 406).

In FIG. 3, when the internal network 1A side transmits the command to the internal network 1B side, it is conceivable that the command is transmitted in response to a request from the internal network 1B side for command transmission. In this case, it can be thought that what is designated in the destination address of the command from the internal network 1A side is not “Address1,” which is a port number or the like on the GW device 10B on the internal network 1B, but a communication device (e.g., the communication device 11B) on the internal network 1B that has requested for command transmission. In this case, the command analysis and translation section 22 extracts the address of the communication device 11B, which is the destination of the command, from the command outputted from the message processing section 23, translates the extracted address of the communication device 11B into a local address on the internal network 1B, and transmits the command to the translated address. Such address translation into a local address is performed in principle by using the address translation table 25. However, if no appropriate address is written in the address translation table 25, the command is transmitted without being subjected to the address translation. In the above example, since the command transmitted from the internal network 1A side to the internal network 1B side is a command addressed to “Address1,” no appropriate address exists in the address translation table 25. Therefore, the command analysis and translation section 22 transmits the command as it is to “Address1,” without performing address translation.

In this embodiment, at Step 404 in FIG. 4, the translated addresses (i.e., global addresses on the external network 2) are extracted, and at Step 405, the global addresses on the external network 2 are written in the destination table 26. However, a step may be provided between Steps 404 and 405 in FIG. 4 to translate the global addresses extracted at Step 404 into local addresses on the internal network 1B, and the local addresses on the internal network 1B may be used as the addresses to be written in the destination table 26 at Step 405. In this case, it is required to add into the GW device 10B another address translation table for translating a global address on the external network 2 into a local address on the internal network 1B.

Moreover, in this embodiment, when content data is communicated between the GW devices 10A and 10B by replaying, downloading and so on, the content data may be communicated by encapsulation like a command. Additionally, to reduce an overhead caused by the encapsulation, the content data may be communicated without encapsulation.

When content data is communicated between the GW devices 10A and 10B without being encapsulated, it is first required not to write a destination address of the content data in the destination table 26. Second, as for the processing of reception of the content data without encapsulation, it is necessary to carry out the reception processing similar to reception of a normal message such as an electronic mail.

As described hereinabove, in the GW device 10A (or 10B) according to this embodiment, the command analysis and translation section 22 translates an address that is contained in a command used on its corresponding internal network 1A (or 1B) and is represented according to the address system used on the internal network 1A (or 1B), into an address represented according to the address system used on the external network 2. Moreover, the message processing section 23 encapsulates the command subjected to the address translation in a message and transfers the message to the GW device 10B (or 10A) on the other internal network 1B (or 1A) through the external network 2 and the message exchange server 3.

Hence, even when the address system used on the internal networks 1A and 1B differs from the address system used on the external network 2, or even when the address systems used on the internal networks 1A and 1B differ from each other, the communication devices connected to the different internal networks 1A and 1B can communicate a command required for content communication through the external network 2. Therefore, the communication devices can obtain the content data from one another based on the command, for example, by playing the content data, downloading the content data, and so on.

Further, according to the embodiment, a new platform does not need to be constructed because a command is communicated by utilizing a platform for message services (e.g., electronic mail messages, instant messages, etc.) provided by a message exchange server, which has been already constructed on a communication device in an ordinary home. In addition, for this reason, a communication device can be provided at low cost, and no knowledge of high-degree networking is required of a user.

Furthermore, since the message services provided by the message exchange server are utilized, it is possible to communicate a command within a range in which a message can be communicated. For example, even if the protocol at a lower layer differs from that of another, or even if the communication of data is restricted for the reason of security, a command can be communicated as long as the communication is performed within a range in which a message can be communicated.

Additionally, since a command is communicated by being encapsulated in a message, the system can easily accommodate the function extension of an internal network. For example, a gateway device basically does not need to be changed even when a new command is defined in a protocol used on its corresponding internal network. In this case, it suffices that only a communication device connected to an end of the internal network will handle the newly defined command.

1. A communications system comprising:
a plurality of gateway devices each corresponding to a plurality of first networks, wherein each of the gateway devices connects a corresponding first network and a second network; and
a message exchange server connected to the second network, wherein the message exchange server allows message communications between the gateway devices through the second network,
wherein each of the gateway devices comprises:
an address translator for translating a first address represented according to a first address system on the first network into a second address represented according to a second address system on the second network to produce an address-translated command, wherein the first address is included in a predetermined command received from a corresponding first network; and
a message processor for encapsulating the address-translated command in a message to transmit the message to another gateway device through the message exchange server over the second network.

2. The communications system according to claim 1, wherein, when the predetermined command is a command necessary for content communication, the address translator translates each of a device address and a content address included in the predetermined command as a first address, wherein the device address identifies a communication device which is a source of the predetermined command within the corresponding internal network and the content address identifies content data to be provided by the communication device.

3. The communications system according to claim 1, wherein the gateway device further comprises:
an address translation table storing an address represented according to the first address system and an address represented according to the second address system, which are related to each other,
wherein the address translator writes a before-translation address and an after-translation address onto the address translation table when address translation of the first address has been done.

4. The communications system according to claim 1, wherein the gateway device further comprises:
a destination table storing a destination address of the predetermined command to be encapsulated in the message and a transfer destination address of the message, the transfer destination address being an address of the other gateway device to which the message is to be transmitted, wherein the destination address and the transfer destination address are related to each other,
wherein when the destination address is included in the destination table, the address translator performs address translation of the first address,
wherein when the destination address is included in the destination table, the message processor encapsulates the address-translated command in the message to transfer the message to the other gateway device whose address is the transfer destination address related to the destination address in the destination table.

5. The communications system according to claim 4, wherein when having received a message from the other gateway device through the message exchange server over the second network, the message processor decapsulates the message received to extract a received command,
wherein the address translator translates an address included in the received command from the second address system into the first address system as necessary before transmitting an address-translated received command to the first network.

6. The communications system according to claim 5, wherein, when the received command is a command necessary for content communication and includes a content address for identifying content data, the address translator newly writes the content address and a source address of the received command indicative of the address of the other gateway device, as the destination address and the transfer destination address of the destination table, respectively.

7. The communications system according to claim 1, wherein the message processor transmits the message in text format to the other gateway device.

8. The communications system according to claim 1, wherein the plurality of first networks each are home networks and the second network is the Internet.

9. A gateway device corresponding to each of a plurality of first networks, wherein the gateway device connects a corresponding first network and a second network and allows message communication with a message exchange server through the second network, comprising:
an address translator for translating a first address represented according to a first address system on the first network into a second address represented according to a second address system on the second network to produce an address-translated command, wherein the first address is included in a predetermined command received from a corresponding first network; and
a message processor for encapsulating the address-translated command in a message to transmit the message to another gateway device through the message exchange server over the second network.

10. The gateway device according to claim 9, wherein, when the predetermined command is a command necessary for content communication, the address translator translates each of a device address and a content address included in the predetermined command as a first address, wherein the device address identifies a communication device which is a source of the predetermined command within the corresponding first network and the content address identifies content data to be provided by the communication device.

11. The gateway device according to claim 9, further comprising:
an address translation table storing an address represented according to the first address system and an address represented according to the second address system, which are related to each other,
wherein the address translator writes a before-translation address and an after-translation address onto the address translation table when address translation of the first address has been done.

12. The gateway device according to claim 9, further comprising:
a destination table storing a destination address of the predetermined command to be encapsulated in the message and a transfer destination address of the message, the transfer destination address being an address of the other gateway device to which the message is to be transmitted, wherein the destination address and the transfer destination address are related to each other,
wherein when the destination address is included in the destination table, the address translator performs address translation of the first address,
wherein when the destination address is included in the destination table, the message processor encapsulates the address-translated command in the message to transfer the message to the other gateway device whose address is the transfer destination address related to the destination address in the destination table.

13. The gateway device according to claim 12, wherein when having received a message from the other gateway device through the message exchange server over the second network, the message processor decapsulates the message received to extract a received command,
wherein the address translator translates an address included in the received command from the second address system into the first address system before transmitting an address-translated received command to the first network.

14. The gateway device according to claim 13, wherein, when the received command is a command necessary for content communication and includes a content address for identifying content data, the address translator newly writes the content address and a source address of the received command indicative of the address of the other gateway device, as the destination address and the transfer destination address of the destination table, respectively.

15. The gateway device according to claim 9, wherein the message processor transmits the message in text format to the other gateway device.

16. The gateway device according to claim 9, wherein the plurality of first networks each are home networks and the second network is the Internet.

17. A communication method between a plurality of gateway devices, each of which corresponds to one of a plurality of first networks, wherein the gateway device connects a corresponding first network and a second network and allows message communication with a message exchange server through the second network, the communication method comprising:
at each of the gateway devices,
translating a first address represented according to a first address system on the first network into a second address represented according to a second address system on the second network to produce an address-translated command, wherein the first address is included in a predetermined command received from a corresponding first network;
encapsulating the address-translated command in a message; and
transmitting the message to another gateway device through the message exchange server over the second network.

18. A communication method in a gateway device which is provided for each of a plurality of first networks, wherein the gateway device connects a corresponding first network and a second network and allows message communication with a message exchange server through the second network, comprising:
translating a first address represented according to a first address system on the first network into a second address represented according to a second address system on the second network to produce an address-translated command, wherein the first address is included in a predetermined command received from a corresponding first network;
encapsulating the address-translated command in a message; and
transmitting the message to another gateway device through the message exchange server over the second network.

19. A computer-readable medium recording a program for instructing a computer to function as a gateway device which is provided for each of a plurality of first networks, wherein the gateway device connects a corresponding first network and a second network and allows message communication with a message exchange server through the second network, the program comprising the steps of:
translating a first address represented according to a first address system on the first network into a second address represented according to a second address system on the second network to produce an address-translated command, wherein the first address is included in a predetermined command received from a corresponding first network;
encapsulating the address-translated command in a message; and
transmitting the message to another gateway device through the message exchange server over the second network.

20. A communications system comprising:
a plurality of gateway devices each corresponding to a plurality of first networks, wherein each of the gateway devices connects a corresponding first network and a second network; and
a message exchange server connected to the second network, wherein the message exchange server allows message communications between the gateway devices through the second network,
wherein each of the gateway devices comprises:
means for translating a first address represented according to a first address system on the first network into a second address represented according to a second address system on the second network to produce an address-translated command, wherein the first address is included in a predetermined command received from a corresponding first network; and
means for encapsulating the address-translated command in a message to transmit the message to another gateway device through the message exchange server over the second network.

21. A gateway device corresponding to each of a plurality of first networks, wherein the gateway device connects a corresponding first network and a second network and allows message communication with a message exchange server through the second network, comprising:
means for translating a first address represented according to a first address system on the first network into a second address represented according to a second address system on the second network to produce an address-translated command, wherein the first address is included in a predetermined command received from a corresponding first network; and
means for encapsulating the address-translated command in a message to transmit the message to another gateway device through the message exchange server over the second network.
